(19) United States
(12) Patent Application Publication
(10) Pub. No.: US 2026/0368624 A1
(43) Pub. Date: Nov. 19, 2026

(54) VARIABLE DIMENSION DISPARATE PLATFORM GENERATIVE MODEL TUNING

(71) Applicant: THE HUNTINGTON NATIONAL BANK, Columbus, OH (US)

(72) Inventors: Robert Carnell, Columbus, OH (US); Spencer S. Gibson, Columbus, OH (US); Jeffrey S. Lehman, Columbus, OH (US); Qianhuizi Deng, Columbus, OH (US); Summer Long, Columbus, OH (US)

(73) Assignee: THE HUNTINGTON NATIONAL BANK, Columbus, OH (US)

(21) Appl. No.: 19/209,451

(22) Filed: May 15, 2025

Related U.S. Application Data
(63) Continuation of application No. 19/209,173, filed on May 15, 2025.

(51) Int. Cl. G06N 20/00

(52) U.S. Cl. CPC G06N 20/00

(57) ABSTRACT

Techniques are described herein for variable dimension disparate platform generative model tuning which may include A computer-implemented method comprising collecting, from a first platform, first input data having a first parameter dimension and a first temporal granularity, collecting, from a second platform, second input data having a second parameter dimension and a second temporal granularity, providing the first and second input data to a generative model, receiving, from the generative model, a distribution of simulated coefficients based at least in part on the first and second input data, determining a decomposition of the distribution of simulated coefficients, determining a posterior distribution based at least in part on the decomposition, and training the generative model with the posterior distribution to define a trained generative model.

### CROSS-REFERENCE TO RELATED APPLICATION

This is a continuation of U.S. patent application Ser. No. 19/209,173, filed May 15, 2025, and titled “VARIABLE DIMENSION DISPARATE PLATFORM GENERATIVE MODEL TUNING USING POSTERIOR DISTRIBUTIONS,” the entirety of which is incorporated herein by reference.

### BACKGROUND

Disparate data sources often have different data formats, structures, quality levels, and various distributions. Correctly tuning generative models using disparate data sources can lead to challenges and inconsistencies in aligning the data for producing reliable and consistent results. These inconsistencies can lead to problems like overfitting and/or improper estimates on newly input data.

### FIELD

The present disclosure is directed to tuning models. More particularly, the present disclosure describes components, methods, and systems to tune a generative model using variable dimension disparate platforms.

### BRIEF SUMMARY

Techniques are provided for variable dimension disparate platform generative model tuning. Various embodiments are described herein, including methods, systems, non-transitory computer-readable storage media storing programs, code, or instructions executable by one or more processors, and the like.

One embodiment is directed to a computer-implemented method comprising collecting, from a first platform, first input data having a first parameter dimension and a first temporal granularity; collecting, from a second platform, second input data having a second parameter dimension and a second temporal granularity, providing the first and second input data to a generative model; receiving, from the generative model, a distribution of simulated coefficients based at least in part on the first and second input data; determining a decomposition of the distribution of simulated coefficients; determining a posterior distribution based at least in part on the decomposition; and training the generative model with the posterior distribution to define a trained generative model.

In some embodiments, the first parameter dimension is different than the second parameter dimension and the first temporal granularity dimension is different than the second temporal granularity dimension.

In some embodiments, the first platform and the second platform are disparate platforms.

In some embodiments, the posterior distribution incorporates historical values to mitigate overfitting observed data and the distribution of simulated coefficients by the generative model.

In some embodiments, the method further comprises determining one or more external factors based on a prior generative model output; applying the one or more external factors to the first or second input; and retraining the generative model based at least in part on the external factors.

In some embodiments, the method further comprises training one or more additional generative models based at least in part on the decomposition and the external factors.

In some embodiments, the platform functions are based at least in part on platform simulations for the platforms from the machine learning model.

In some embodiments, the method further comprises providing a third input to the trained generative model, wherein the third input is associated with a third set of platforms having a set of third parameter dimensions; and receive, from the trained generative model, a distribution of likely outcomes for each dimension within the set of third parameter dimensions.

In some embodiments, the method further comprises sampling variables from the third parameter; generate a set of confidence intervals for each platform of the third set of platforms, wherein each confidence interval of the set of confidence intervals is generated for each variable sampled from the third parameter and based at least in part on the posterior distribution.

In some embodiments, a system comprises one or more processors and one or more memories storing computer-executable instructions that, when executed by the one or more processors, causes the one or more processors to perform the method(s) disclosed herein.

In some embodiments, a non-transitory computer-readable storage medium storing computer-executable instructions that, when executed with one or more processors of a computing device, causes the computing device to perform the method(s) disclosed herein.

### BRIEF DESCRIPTION OF THE DRAWINGS

Various embodiments in accordance with the present disclosure will be described with reference to the drawings, in which:

FIG. 1 is a simplified example flow for tuning a generative model using disparate platforms with variable dimensions, in accordance with at least one embodiment;

FIG. 2 is a simplified diagram for example variables for platforms and events, in accordance with at least one embodiment;

FIG. 3 is a simplified diagram illustrating an example process for combining variables, in accordance with at least one embodiment;

FIG. 4 is a simplified diagram illustrating example bounds for variables, in accordance with at least one embodiment;

FIG. 5 is a simplified diagram illustrating example tuning of a generative model using bounds and an optimization metric, in accordance with at least one embodiment;

FIG. 6 is a simplified diagram illustrating a generative model outputs, in accordance with at least one embodiment;

FIG. 7 is a simplified diagram illustrating an example system architecture, in accordance with at least one embodiment;

FIG. 8 is a simplified diagram illustrating an example generative model architecture, in accordance with at least one embodiment;

FIG. 9 is a block diagram illustrating an example method for tuning a generative model, in accordance with at least one embodiment; and

FIG. 10 is a block diagram illustrating an example method for detecting fraudulent transactions, in accordance with at least one embodiment.

### DETAILED DESCRIPTION

In the following description, various embodiments will be described. For purposes of explanation, specific configurations and details are set forth to provide a thorough understanding of the embodiments. However, it will be apparent to one skilled in the art that the embodiments may be practiced without the specific details. Furthermore, well-known features may be omitted or simplified in order not to obscure the embodiment being described.

Some or all of the process (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

Throughout this disclosure the term “tune” is used in relation to one or more generative model(s). This term is not intended to be considered limiting and, unless otherwise defined, is used to describe one or more actions (e.g., train, modify, adjust, etc.) performed on generative model(s).

Disparate data sources conventionally use data source-dependent preprocessing to remove and/or mitigate data type inconsistencies from different sources (e.g., platforms). This adds complexity to the data preparation processes and makes processing this data by generative models (e.g., large language models) complex and processor intensive. Additionally, dimensional variables (e.g., data files which have multiple data points, “transport” “amount” “buy” “spend”) to be extracted from different platforms (e.g., transportation, semiconductor manufacturing, television advertisements) may not be, at least initially, directly comparable which adds further complexity and processing power additions to the generative models to produce consistent outputs. Moreover, different platforms (e.g., different hospitals, manufacturers, etc.) may use various data granularities (e.g., temporal granularities by day, week, month, etc.) which compounds the previously discussed deficiencies. Coupled with these deficiencies are difficulties in tuning a generative model across different platforms (e.g., transportation versus banking) that have various data outputs and which may be affected by external factors such as geological events (e.g., disasters).

Techniques are provided to tune a generative model using data from various platforms (e.g., data providers) which may or may not have common factors. Additionally, external factors like, for example, geopolitical events or physical location may be used to tune the generative model to produce catered outputs associated with real-world events. For example, the generative model may receive the data from the various data platforms and leverage the data against the external factors (e.g., labeled data) to produce outputs which are factor adjusted and are more sensitive to real-world events which cannot be always predicted or anticipated. The data from the various platforms and the external factors may tune the generative model to incorporate, and/or consider potential real-world events (e.g., anticipated elections) when producing outputs associated with multidimensional variables from the platforms. In addition, priors (e.g., initial assumptions prior to observations) and bounds (e.g., range within which a true distribution parameter is likely to fall within a certain level of confidence) may be leveraged to enhance the tuning of the generative model by enabling an optimization metric to be created. The optimization metric improves the generative models ability to create more accurate estimations on metrics between the platforms by facilitating creation of representative samples for the platforms by simulating likely scenarios to occur.

Various aspects of the present disclosure improve the technical field of tuning generative models by applying real-world data (e.g., observations) with measured data from multidimensional variable data sources to increase accuracy and up-to-date relevancy of the generative model. Additionally, the generative model may be continuously updated according to various time intervals to mitigate data overfitting and improving accuracy of simulated scenarios associated with the multidimensional variable data sources. Moreover, the present disclosure compares actual versus simulated values to validate posterior measurements and performs operations to continually improve accuracy of simulated values.

The present disclosure provides various technical advantages and improvements over conventional methods and devices. For example, tuning and running the generative model using methods described herein, the generative models are able to make efficient predictions on new data by learning patterns from the training data, effectively compressing information and allowing for more efficient data transmission, which in turn may effectively reduce how much data is used to for new queries and analysis. This is particularly useful in networks with network latency limitations (e.g., small networks of computers). The generative model can perform calculations on new data locally which reduces network strain by reducing (or eliminating) communications (e.g., reducing data footprint) with a cloud and/or service provider due to the generative models flexibility in incorporating data sources which a spread of variable dimensions (e.g., data points with at least one commonality).

In addition to the previously mentioned technical improvements, input data does not need to be pre-formatted since the tuned generative model is trained on variable disparate platforms which reduces processing power needed to analyze the data as compared to conventional models which either utilize extra steps (or even extra models) to analyze disparate platforms and/or variable dimensions associated with the disparate platforms. By leveraging relevant patterns from input data, the tuned generative models are able to efficiently utilize process power (reducing overall processing power) to generative accurate simulations (e.g., predictions on future values). Moreover, a time to process input data is reduced since the extra step of formatting the input data is not always necessary which saves time and computing resources.

Methods and processes described herein provide for a flexible, adaptive, and adjustable generative model which may be tuned iteratively. The iterative tuning includes transforming input data from multi-dimensional platforms which may or may not have commonalities. The data may be used to create tuning data sets which adaptively adjust the generative models to reduce data processing power (e.g., by filtering out irrelevant data) of the generative models compared to conventional models (e.g., large language models).

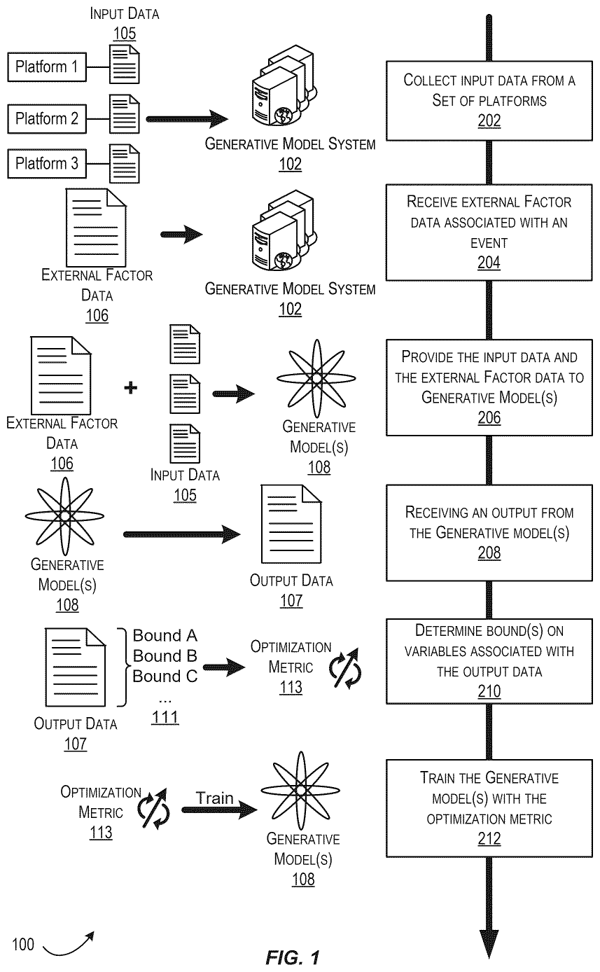

FIG. 1 is a simplified example flow 100 for tuning a generative model using disparate platforms with variable dimensions, in accordance with at least one embodiment. The operations discussed in connection with FIG. 1 may be performed with a generative model system 102 (hereinafter “GMS 102”). In some embodiments, GMS 102 may be implemented by one or more computer(s), as a service, within an application, or the like. The operations discussed in connection with FIG. 1 may be performed in any suitable order. More or fewer operations than those depicted in FIG. 1 may be employed without diverting from this disclosure.

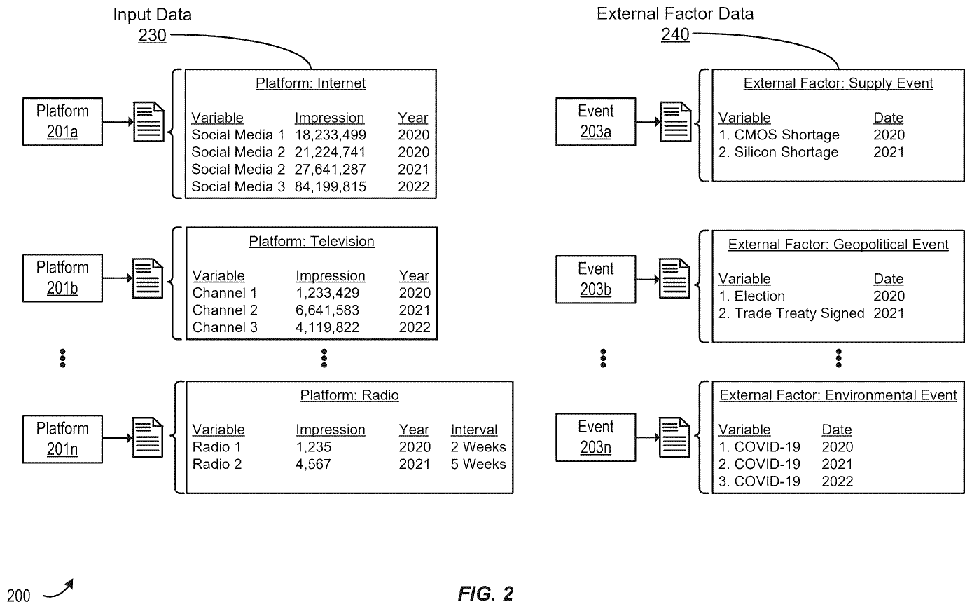

The flow may begin at 202 where a GMS 102 may collect input data 105 (e.g., input data 230 as discussed in more detail with respect to FIG. 2) from a set of platforms (e.g., platforms 201a-201n as discussed in more detail with respect to FIG. 2). The input data 105 may be multidimensional and include any suitable number of variables associated with respective platforms. The input data 105 may be selected by a user (e.g., subject matter expert), may have been previously labeled (e.g., assigned context and/or meaning), or may be selected in an automated manner.

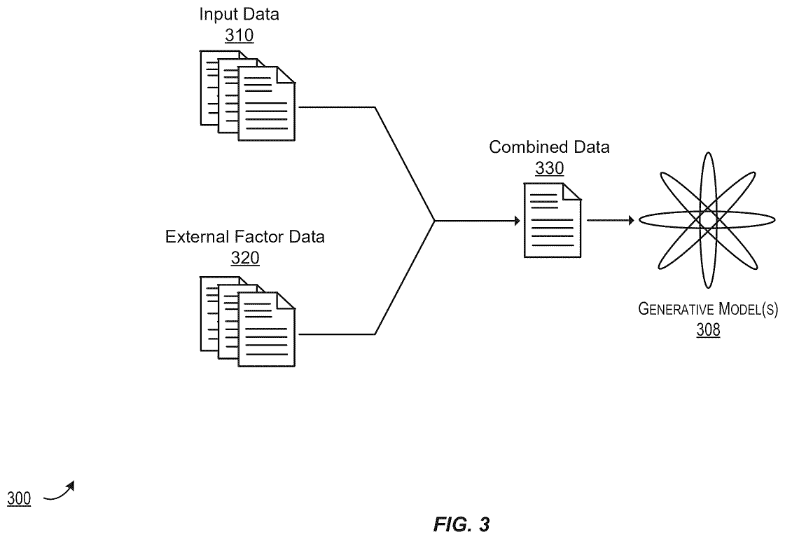

At 204, the GMS 102 may receive external factor data 106 (e.g., external factor data 320 as discussed in more detail with respect to FIG. 3). The external factor data 106 may be associated with an event (e.g., real-world event) that affected at least one of the platforms. For example, for a semi-conductor manufacturer (platform) reporting supply variables (multidimensional variables) over the month of October may be affected by a transport bottleneck (event) which occurred mid-October thus causing the supply variables to shift with respect to what would have been a normal October compared to previous years.

At 206, the GMS 102 may provide the input data 105 and the external factor data 106 to one or more generative model(s) 108 (e.g., large language models (LLM)) to begin tuning operations. For example, the input data 105 may be provided to the generative model(s) 108 in a raw form (e.g., unedited from the platform), may receive the input data 105 in a catered form from the GMS 102 (e.g., edited to a normalized format), and/or may receive the input data 105 in any other suitable manner. The external factor data 106 may be combined with the input data 105 into a prompt including instructions to perform correlation operations. In some examples, both the input data 105 and the external factor data 106 may include at least some labeled data to enable tuning of the generative model(s) 108. The instructions may request that the generative model(s) 108 identify relevant external factors (e.g., associations) based on prior analysis (e.g., seasonality, distributions, macroenvironment features) and/or prior model development (e.g., previous tuning) and request that the generative model(s) 108 generate simulated function values for each platform.

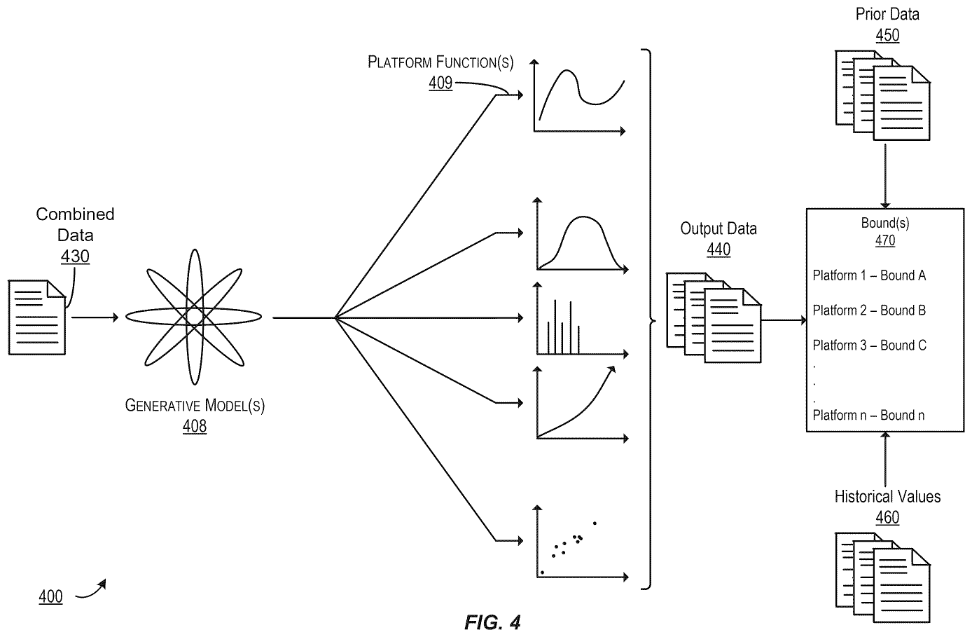

At 208, the GMS 102 may receive an output (e.g., output data 107) from the generative model(s) 208. The output data 107 may include simulated function values for each platform (e.g., platform functions 409 as discussed in more detail with respect to FIG. 4) and may be based at least in part on one or both the input data 105 and/or the external factor data 106.

At 210, the GMS 102 may determine bound(s) (e.g., bounds A-C 111) on variables associated with the output data 107. The bound(s) 111 can be used to provide a range of plausible values for the variables based at least in part on priors (e.g., prior knowledge on data), real-world observation data, and/or historical output data from the generative model(s) 108 to provide support and confidence to simulated values from the generative model(s) 108. An optimization metric 113 may be generated based at least in part on the bound(s) 111 and a sampling (e.g., random sampling) of the variables. The optimization metric 113 may provide meaningful interpretations (e.g., weights) of the variables for the platforms. For example, utilizing the bound(s) 111 and a random sampling of the variables, meaningful upper and lower bounds may provide an optimization metric which weights values that are meaningful in the context of each platform while mitigating generative model solutions which may exist but may not be interpretable in real-world terms or platform specific interpretations. In addition, by leveraging bound(s) 111, the optimization metric 113 may significantly reduce an amount of work, steps, and computational power needed to tune to the generative model(s) 108.

At 212, the GMS 102 may tune the generative model(s) 108 with the optimization metric 113. For example, for a respective generative model 108, the optimization metric 113 may remove and/or reduce irrelevant data (e.g., data which has been observed to be not correlated to the event). In addition, the optimization metric 113 may reduce computational needs by removing and/or reducing the irrelevant data while improving simulated results.

FIG. 2 is a simplified diagram 200 for example variables for platforms and events, in accordance with at least one embodiment. Platforms 201a-201n may represent disparate and/or distinct data sources. The value n may represent a total number of platforms that may send input data to a GMS (e.g., GMS 102 with respect to FIG. 1). By way of a non-limiting example, the platforms 201 may include data sources related to a particular field of activity (e.g., internet, television, and radio are all related to media). The platforms may provide input data 230 which may include multidimensional variables (e.g., variable+impression+year=three dimensions) associated with corresponding values (e.g., variable is associated with values: social media 1, social media 2, and social media 3, impression is associated with values: 18,233,499, 21,224,741, 27,641,287, and 84,199,815, and year is associated with values: 2020, 2021, and 2022). Each platform may include input data 230 with a different amount of dimensions or the same amount of dimensions. Each dimension, respectively, may include any suitable amount of values. When temporal intervals are used, temporal granularity may be defined as a start time to an end time. For example, data captured every week has a higher granularity than data captured every month, and so on. In some examples, a start and end point may not be known since platforms may provide different time scales. In these examples, temporal granularity may be appropriately defined by the GMS and/or the generative model.

External factor data 240 may include data related to one or more events 203a-203n. The value n may represent a total number of external factor data sources that may send input data to a GMS (e.g., GMS 102 with respect to FIG. 1). Each event 203 may may have one or more associated external factors (e.g., supply event, geopolitical event, environmental event, etc.). Similar to the input data 230, the external factor data 240 may include multidimensional variables (e.g., variable, date, etc.) associated with values (e.g., CMOS shortage, silicon shortage, 2020, 2021, etc.). The external factor data 240 may include data associated with, without limitation, a geographic location, a temporal interval, a geopolitical event, technological advancements, cultural trends, competition activity (e.g., competing companies), demographic shifts, seasonal fluctuations (e.g., seasonality), holidays, natural disasters, or combinations thereof. For example, economic conditions like recessions may lead to reduced spending by consumers while economic booms (e.g., growth) is associated with increased spending by consumers. Changes in political landscapes influence consumer spending as well as media buys and spends. New laws that govern advertising practices can also limit media buys and buying options. It should be readily understood that external factors can include any suitable event associated data that may influence one or more variables associated with the platforms. In some examples, the external factor data 240 may be based at least in part on prior generative model development and/or historical data (retrieved from a look-up table).

FIG. 3 is a simplified diagram illustrating an example process 300 for combining variables, in accordance with at least one embodiment. By way of a non-limiting example, input data 310 (which is an example of the input data 230 with respect to FIG. 2) and external factor data 320 (which is an example of the external factor data 240 with respect to FIG. 3) may be combined into combined data 330 in order provide the combined data 330 to the generative model(s) 308. The combined data 330 may be generated by the GMS (e.g., GMS 102 with respect to FIG. 1) and include one or more pre-operations to format the input data 310 and/or the external factor data 320. By way of a non-limiting example, the pre-operations may include dimensionality reductions (e.g., removing one or more dimensional variables) to create new lower-dimensional input data 310 and/or external factor data 320. Other pre-operations may include, without limitation, variable correlation (e.g., linear and non-linear relationships), variable scaling (e.g., reducing variable outliers or weighting outliers differently), variable hashing, variable selection (e.g., identifying the most relevant variables), or combinations thereof. The GMS may perform a domain analysis on the platforms, and/or events. The combined data 330 may then be provided to the generative model(s) 308 for tuning operations. In some examples, the combined data 330 may be provided in one or more forms which may be pre-determined.

FIG. 4 is a simplified diagram 400 illustrating example bounds for variables, in accordance with at least one embodiment. By way of example, one or more generative model(s) 408 may receive combined data 430 (which is an example of combined data 330 with respect to FIG. 3) to produce one or more platform function(s) 409, which may each be associated with a respective platform (e.g., platforms 201a-201n with respect to FIG. 2). While the platform function(s) 409 are depicted as various simplified example charts, it should not be considered limiting, and the charts depicted for clarity to show simplified representations of some example function curves, patterns, associations, and/or trends. In practice, the platform function(s) 409 may include tabulations of values associated, at least in part, with the combined data 430. Output data 440 (which is an example of output data 107 with respect to FIG. 1) may include at least the platform function(s) 409. In some examples, the output data 440 may include the platform function(s) 409 along with the combined data 430.

The platform function(s) 409 may be generated, at least in part, by the GMS performing a temporal decomposition (e.g., a seasonal decomposition: Jan, Feb, March, etc.) of input data prior to combining the data into the combined data 430. The platform function(s) 409 may include platform simulations which include estimates and or future predictions associated, at least in part, on the input data. The platform simulations may include simulations which span a time interval associated with the temporal decomposition. For example, if the temporal decomposition spans an interval of twelve months, the platform simulation may span the same time interval of twelve months may be simulated. It should be understood that the term “simulated” is used herein to represent estimated, predicted, or future values associated with respective platforms. A platform simulation of twelve months, for example, may include predicted values for twelve months based on suitable input data.

According to some embodiments, one or more bound(s) 470 (which may be example of bounds 111 with respect to FIG. 1) may be determined on variables associated with the output data 440 based at least in part on real-world observation data (not depicted) or historical output data (e.g., prior data 450). By way of example, the bound(s) 470 may be based on one or more historical platforms (e.g., platforms with existing variables and values) and/or may be catered per platform (e.g., Platform 1 associated with Bound A, Platform 2 associated with Bound B, Platform 3 associated with Bound C, to platform n associated with bound n, where n is a total number of bounds). In some examples, the bound(s) 470 may be based at least in part on platform associated reference thresholds (e.g., industry benchmarks). The reference thresholds may be associated with confidence intervals for values in the output data 440 (e.g., values are expected to fall within ten percent of historical values and if not, they are rejected or weighted lower). In addition, or alternatively, the bound(s) 470 may be based on historical values 460 (e.g., known value maximums and minimums).

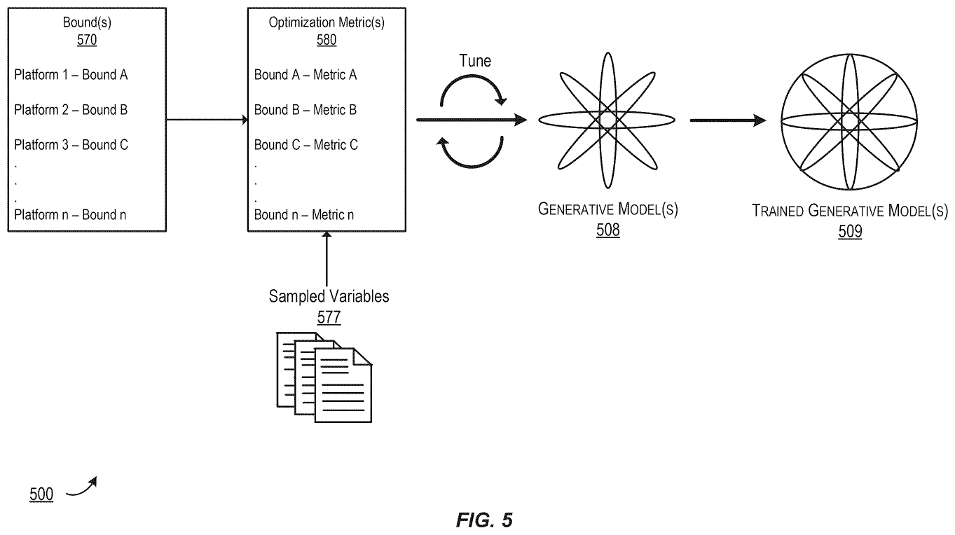

FIG. 5 is a simplified diagram 500 illustrating example tuning of a generative model using bounds and an optimization metric, in accordance with at least one embodiment. By way of a non-limiting example, bound(s) 570 (which are examples of bound(s) 470 with respect to FIG. 4) may be used by a GMS (e.g., GMS 102 with respect to FIG. 1), at least in part, to generate optimization metric(s) 580. For example, a number of bound(s) 570 may be associated with at least one or more optimization metric(s) 580 (e.g., Bound A associated with Metric A, Bound B associated with Metric B, Bound C associated with Metric C, . . . , to Bound n associated with Metric n, where n is a total amount of metrics calculated based on the bound(s) 570).

The optimization metric(s) 580 may be generated based at least in part on the bound(s) 570 and/or a sampling of variables (e.g., sampled variables 577). The sampled variables 577 may be from the input data, the external factor data (e.g., input data 230/external factor data 240 with respect to FIG. 2), the combined data (e.g., combined data 330 with respect to FIG. 3), the output data (e.g., output data 440 with respect to FIG. 4), or combinations thereof. The GMS may obtain current distribution variables (e.g., existing variables and values) from the sampled variables 577 and generate targe distribution variables based at least in part on the input data, the external factor data, the combined data, the output data, or combinations thereof. A set of simulation coefficients (e.g., predicted weights) may be determined based at least in part on the current distribution variables and/or the target distribution variables. The set of simulation coefficients may represent estimates, predictions, future estimates, associated with the platforms (e.g., input data). For example, the simulation coefficients for input data including data values for market buys for advertising new checking accounts from January to December in the year 2024 may include future estimates for market buys between January to December in the year 2025 and accounting for an expected economic boom (e.g., external factor) in May of 2025.

In some examples, generating the optimization metric(s) 580 may include conducting a statistical sampling (e.g., Hamiltonian Monte Carlo Sampling) on at least the output data 440. The statistical sampling may be performed under a statistical framework (e.g., Bayesian inference framework). For example, the framework may be based at least in part on historic behavior of the values and normalized model coefficients, along with respective means and the intervals of posterior distributions, to compare relative coefficient weights (e.g., impact on simulated coefficients). A visual representation of these coefficients has been included as well as the full model output. Various distributions (e.g., negative binomial distributions) may be used across the output data 440 as suitable. The optimization metric(s) 580 may be used to tune (e.g., train) one or more generative model(s) 508 (which may be an example of generative model(s) 408 with respect to FIG. 4) to define a trained generative model(s) 509.

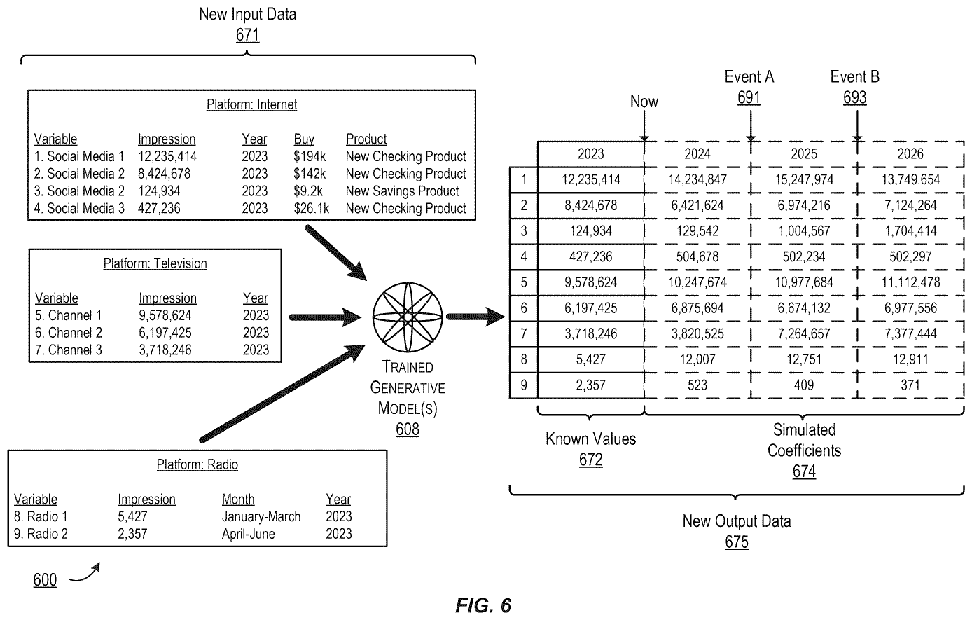

FIG. 6 is a simplified diagram 600 illustrating trained generative model outputs, in accordance with at least one embodiment. By way of example, trained generative model(s) 608 may be used to generate simulated coefficients 674 associated with one or more platforms (e.g., platforms 201a-201n with respect to FIG. 2). For example, new input data 671 (e.g., data which the trained generative model(s) 608 have not previously seen) may be provided to the trained generative model(s) 608. As depicted in this non-limiting example in FIG. 6, the new input data (represented by platform specific input data) may be provided to the trained generative model(s).

The trained generative model(s) 608 may provide new output data 675 including values associated, at least in part, with the new input data. For example, the trained generative model(s) 608 may provide a set of simulated coefficients which may be future estimates associated with each platform (e.g., platforms 1-9) for a given time interval (e.g., from 2024 to 2026). In this example, the simulated coefficients may represent estimated influence metrics (e.g., impression estimates) for each platform for the upcoming years. While impression estimates are shown as an example of the simulated coefficients, it should not be considered limiting, and any suitable simulated coefficient may be generated by the trained generative model(s) 608 (e.g., as provided in the instructions in a prompt). Known values 672 may represent historical values (e.g., historical values 460 with respect to FIG. 4). Event A 691 and Event B 693 may represent known and/or predicted events that may occur during the time interval assessed by the trained generative model(s) 608.

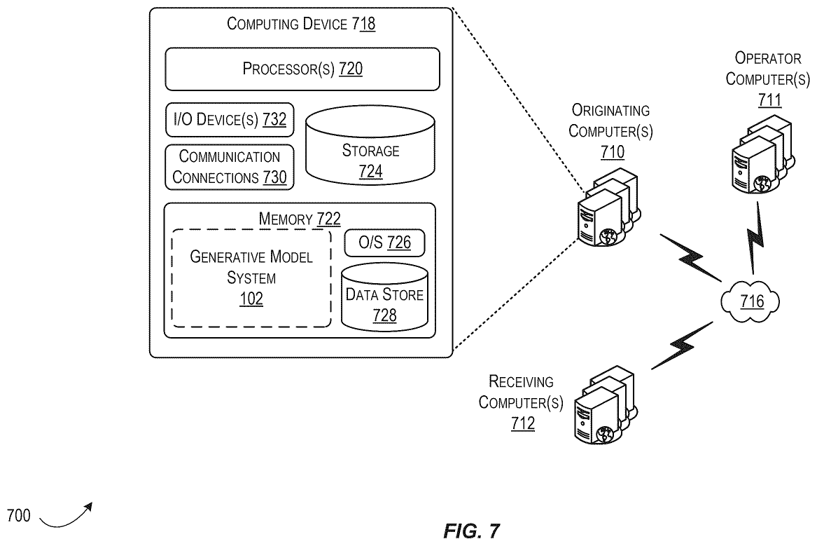

The new output data 675 may be used to determine an estimated influence metric associated with at least one user associated with the platforms in the new input data 671. The GMS may generate a report, summary, recommendation, or suitable equivalent to display on a graphical user interface (GUI) (e.g., using I/O device(s) 732 with respect to FIG. 7). The report, for example, may include the simulated coefficients 674, or related metrics associated with the new output data 675. In some examples, the new input data 671 may be used to tune (e.g., train) the trained generative model(s) 608. Similar to, or the same as, the techniques, processes, and procedures described with respect to FIGS. 1-5, the trained generative model(s) 608 may be retrained using previous external factor data and/or new external factor data. As previously mentioned, the trained generative model(s) 608 may produce a set of simulated coefficients (e.g., simulated coefficients 674). The trained generative model(s) 608 may then be retrained using at least some of the simulated coefficients and historically determined simulated coefficients (e.g., from different input data and/or platforms). In this example, input data (e.g., input data 310 with respect to FIG. 3) may be combined with the new input data 671 to provide as a combined input data to the trained generative model(s) 608. The trained generative model(s) 608 may then generate a new set of simulated coefficients which are based at least in part on the input data, the new input data, or both.

FIG. 7 is a simplified diagram illustrating an example system 700, in accordance with at least one embodiment. The system 700 may be incorporated as a component and/or work in conjunction with devices, systems, and methods herein. System 700 may be an example of generative model tuning system in which a variety of computing devices may interact to provide a reliable system for tuning one or more generative model(s). The system 700 may be used for a variety of tuning operations and producing simulated coefficients related to one or more platforms, including but not limited to, market buy predictions, impression predictions, seasonality weightings on new products, and the like.

Originating Computer(s) 710 may be operated on behalf of an originator (a e.g., a bank, financial institution, or another entity) that initially has access to input data (e.g., input data 105 with respect to FIG. 1). An input data may include any suitable number of variables, data instances values, data instance types, categories, subcategories, classifications, codes, identifiers, names, amounts/values, impressions, any suitable number of descriptors, or combinations thereof. As a non-limiting example, variables can include platform types, values associated therewith, time intervals, market buys, market sells, types of products, or the like.

In some embodiments, Operator Computer(s) 711 may be configured to receive data instances/input data from various Originating Computer(s) 710 and may process and/or forward any suitable data related to those data instances to Receiving Computer(s) 712 (e.g., client devices associated with users). Operator Computer(s) 711 may be further configured to perform functions for the participating entities. Receiving Computer(s) 712 may be operated on behalf of another entity and may be configured to receive data instances/input data from the Operator Computer(s) 711. Receiver Computer(s) 712 may be operator on behalf of a consumer, corporation, or entity that has previously authorized the originator associated with the Operator Computer(s) 710 to initiate the operation (e.g., tune one or more generative model(s)).

The Originating Computer(s) 710, the Operator Computer(s) 711, the Receiving Computer(s) 712, may each be an example of the computing device 718. In some embodiments, the computing device 718 and may include one or more processors (e.g., processor(s) 420). The processor(s) 720 may be implemented in hardware, computer-executable instructions, firmware, or combinations thereof. Computer-executable instruction or firmware implementations of the processor(s) 720 may include computer-executable or machine-executable instructions written in any suitable programming language. Computing device 718 may include memory 722. The memory 722 may store computer-executable instructions that are loadable and executable by the processor(s) 720, as well as data generated during the execution of these programs. The memory 422 may be volatile (such as RAM) and/or non-volatile (such as ROM, flash memory, etc.). The computing device 718 may include additional storage (e.g., storage 724), which may include removable storage and/or non-removable storage. Storage 724 may include, but is not limited to, magnetic storage, optical disks and/or tape storage. The disk drives and their associated computer-readable media may provide non-volatile storage of computer-readable instructions, data structures, program systems, and other data for the computing devices.

The memory 722 and/or storage 724 may be examples of computer-readable storage media. Computer-readable storage media may include volatile, or non-volatile, removable, or non-removable media implemented in any method or technology for storage of information such as computer-readable instructions, data structures, program systems, or other data. In some embodiments, memory 722 and the storage 724 are examples of computer storage media. Memory 722 and/or additional storage 724 may include, but are not limited to, any suitable combination of PRAM, SRAM, DRAM, RAM, ROM, EEPROM, flash memory or other memory technology, CD-ROM, DVD, magnetic tape, magnetic disk storage or other magnetic storage devices, or any other medium which can be used to store desired information, and which can be accessed by the computing device 718. Computer-readable media may include computer-readable instructions, program systems, or other data transmitted within a data signal, such as a carrier wave, or other transmission. However, as used herein, computer-readable storage media does not include computer-readable communication media.

The memory 722 may include an operating system 726 and one or more data stores 728, and/or one or more application programs, systems, or services. The computing device may also contain communications connection(s) 730 that allow the computing device 718 to communicate with a stored database, another computing device, a server, user terminals and/or other devices (e.g., via one or more networks, not depicted). The computing device may also include I/O device(s) 732, such as a graphical user interface (GUI), keyboard, a mouse, a pen, a voice input device, a touch input device, a display, speakers, a printer, etc. In some embodiments, the memory 722 may store instructions that, when executed by processor(s) 720 implement the functionality described herein with respect to a generative model system (GMS) (e.g., the GMS 102 with respect to FIG. 1). By way of example, Receiving Computer(s) 712 may execute the instructions for GMS 102 to provide the functionality described above in connection with FIGS. 1-6, 9, and 10. In some embodiments, the GMS 102 may execute on any suitable computer depicted in FIG. 7.

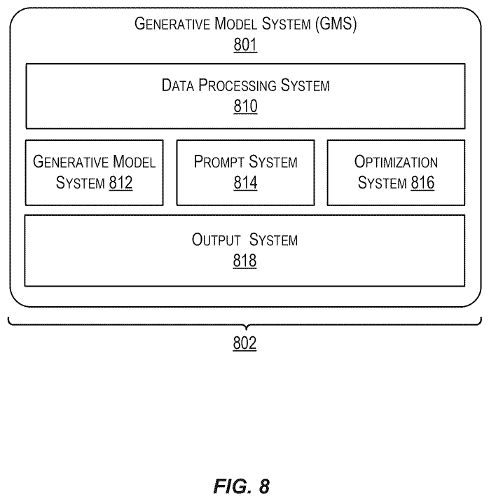

FIG. 8 is a simplified diagram 800 illustrating an example generative model architecture, in accordance with at least one embodiment. The GMS 801 may support processes, methods, operations, and techniques discussed in connection with the FIGS. 1-6, 9, and 10 and execute as a separate system or as part of the receiving computer(s) 712 of FIG. 7. Systems 802 may be systems and/or sub-systems. While the systems 802 are depicted with a particular structure, it is not to be considered limiting and the systems 802 may be arranged with any suitable organizational and/or communication structure. The systems 802 of GMS 801 may be software systems, hardware systems, or a combination thereof. If the systems are software systems, the systems can be embodied on a computer readable medium and processed by a processor in any of the computer systems described herein. It should be noted that any system or data store described herein, may be, in some embodiments, be a service responsible for providing functionality corresponding to the system described below. The systems 802 may be execute as part of the GMS 801, or the systems 802 may exist as separate systems or services external to the GMS 801. In some embodiments, the systems 802 may be executed by the same or different computing devices, as a service, as an application, or the like.

Data processing system 810 may include any suitable processing components (e.g., software, hardware, firmware, etc.) operable to support functions, operations, communications, etc. between one or more of systems 812, 814, 816, 818. The data processing system 810 may function to transmit, receive, and/or otherwise communicate with one or more systems or devices over one or more communication networks (e.g., the Internet, wide area networks “WAN”, local area networks “LAN”, an automated clearinghouse network, etc.). While not depicted, the data processing system 810 need not be physically local to the GMS 801, and may function, at least in part, as a component of a larger network (e.g., cloud network or similar). The data processing system 810 may include any suitable number of supporting hardware components such as processor(s) (e.g., such as processor(s) 720 of FIG. 7), controller(s) (e.g., analog, digital, FPGA, etc.), server(s), non-transitory computer readable mediums such as memory such as RAM and/or ROM (e.g., memory 722 of FIG. 7). The data processing system 810 may be configured to store, retrieve, or transmit such data according to a predetermined periodicity, schedule (e.g., every microsecond, every hour, every day, etc.), frequency, or by request (e.g., user request). In some embodiments, the data processing system 810 may be configured to receive input data (e.g., data instances corresponding to one or more payment transactions, data instances corresponding to a banking account, etc.).

Generative model system 812 may include any suitable number of programs, algorithms, computer readable instructions, that, when executed, interface with a suitable machine-learning model (e.g., an LLM). The Generative model system 812 may contain a look-up table or other predefined data indicating a set of pre-existing model providers (e.g., OpenAI™). In some embodiments, the generative model system 812 may provide a list of LLM providers to a user (e.g., developer, client, etc.) enabling the user to select an LLM provider from the list. The generative model system 812 may be configured to store any suitable data corresponding to respective LLMs within a data store. By way of example, generative model system 812 may be configured to store formatting information indicating one or more attributes, characteristics, application programming interfaces, prompt format, or any suitable data related to one or more LLMs/LLM providers.

Prompt System 814 may include any suitable number of programs, algorithms, computer readable instructions, that, when executed, generate a prompt for the GMS 801. The prompt system 814 may obtain input data from the data processing system 810. The prompt system 814 may provide input data (e.g., input data 310, external factor data 320, combined data 330, etc. with respect to FIG. 3) as input to an algorithm and/or model in order to transform the input data into the prompt. The prompt system 514 may be configured to partition some or all parts of the input data into various formats which are suitable for one or more generative model(s) (e.g., according to a format associated with a respective model such as a LLM). In some embodiments, the prompt system 814 is configured to communicate with output system 818 based at least in part on prompt generated from the model. In some embodiments, prompt system 814 may provide the prompt to the generative model based at least in part on one or more application programming interfaces identified. The prompt system 514 may be configured to store, retrieve, or transmit such data according to a predetermined periodicity, schedule (e.g., every hour, every day, etc.), frequency, or by request (e.g., user request). As a non-limiting example, the prompt system 514 may be configured to receive and/or obtain one or more data instances corresponding to a platform (e.g., one or more market buys for a platform). In some embodiments, the one or more data instances may include a most-recent data instance (e.g., a most-recent payment transaction).

Optimization system 818 may include any suitable number of programs, algorithms, computer readable instructions, that, when executed, determine one or more optimization metrics (e.g., optimization metrics 580 with respect to FIG. 5). The optimization system 818 may capture data needed to form good predictions around new platforms to tune generative models to generate simulated coefficients (e.g., estimated predictions). The optimization system 818 may generate distributions of historical data (e.g., posterior distributions based on one or more variables from the platforms) and leverage the distributions in order to generate accurate and reliable optimization metrics. After conducting sampling, the optimization system 818 may summarize the simulated coefficients along with their respective means and the intervals of their posterior distributions to compare relative impacts to produce weighted values. The posterior distributions may be used as a “dummy” check to ensure that the distribution is not overfitting observed data and simulated coefficients. For example, the posterior distribution incorporates historical values to mitigate overfitting observed data and the distribution of simulated coefficients (e.g., check to make sure the model reflects real world observations) by the generative model. The optimization system 818 may additionally assess generative model accuracy and may review generative model fidelity according to a duty cycle (e.g., quarterly). The optimization system 818 may leverage backward looking model outputs to understand the likelihood of performance by platform in the future on new platforms. For example, posterior predictive checks, convergence diagnostics and R-Squared are used to understand accuracy.

Output system 518 may include any suitable number of programs, algorithms, computer readable instructions, or similar to control, interact, provide feedback, provide alerts, provide notifications, and/or operations in response to one or more of the systems 802 performing operations. The output system 818 may include functionality to communicate with one or more user device(s) (e.g., such as receiving computer(s) 712 of FIG. 7 via communication connections 730 of FIG. 7). The operation(s) may include aggregated information from systems 802. For example, the operation(s) may include transmitting a notification to one or more user device(s) that provides a report and/or summary view of the output of tuned (e.g., trained or retrained) generative models. In some embodiments, the output system 818 is configured to generate reports, tune generative model(s), store historical values, generate graphs, generate executive summaries, display user friendly interfaces for interacting with data discussed within the scope of the present disclosure, or suitable equivalents. In some embodiments, the output system 818 may present any suitable simulation parameters corresponding to predictions, information, categories, subcategories, and/or influence metrics (or similar) identified by the output data obtained from generative model. The output system 818 may aggregate data instances based at least in part on these labels in order to provide a collective view of the data instances corresponding to each label. The output system 818 may be configured to store, retrieve, or transmit such data according to a predetermined periodicity, schedule (e.g., every hour, every day, etc.), frequency, or by request (e.g., user request).

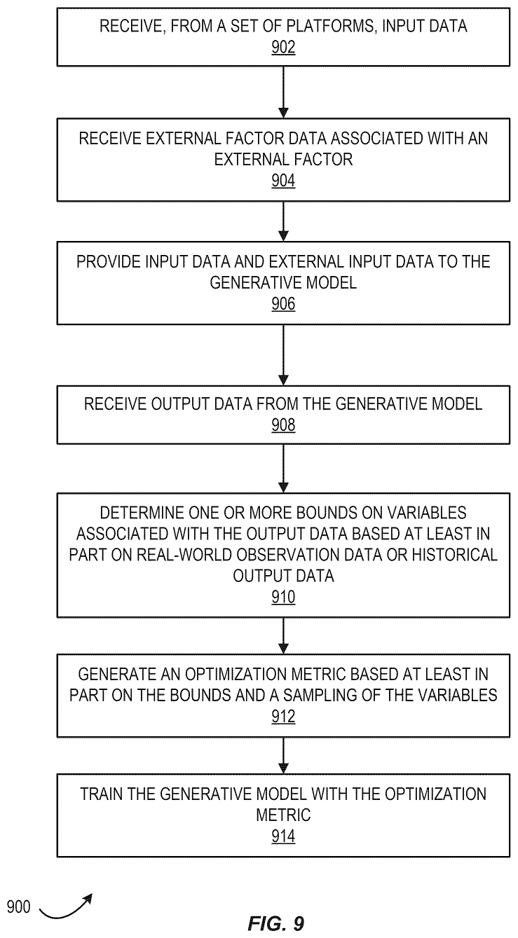

FIG. 9 is a block diagram illustrating an example method 900 for tuning a generative model, in accordance with at least one embodiment. A non-transitory computer-readable storage medium may store computer-executable instructions that, when executed by at least one processor, cause at least one computer to perform instructions comprising the operations of the method 900. It should be appreciated that the operations of the method 900 may be performed in any suitable order, not necessarily the order depicted in FIG. 9. Further, the method 900 may include additional, or fewer operations than those depicted in FIG. 9. The operations of method 900 may be performed by any suitable portion of the device of FIG. 1 which may include one or more computing devices such as computing device 718 of FIGS. 7 and/or 8.

The method 900 may begin at 902, where a generative model system (GMS) (e.g., GMS 102 with respect to FIG. 7) may receive, from a set of platforms (e.g., platforms 201a-201n with respect to FIG. 2), input data (e.g., input data 105 with respect to FIG. 1). The platforms may be disparate platforms which may or may not have common data. The platforms may each provide input data which may include multiple dimensions (e.g., columns, rows, values, etc.).

At 904, the GMS may receive external factor data (e.g., external factor data 240 with respect to FIG. 2) associated with an external factor (e.g., a geographic location, a temporal interval, a geopolitical event, or combinations thereof). For example, the external factor could be new legislation which limits how much money can be spent on an advertising spend for AmazingProductXYZ, and so platforms such as television for advertising for AmazingProductXYZ would be less effective due to a smaller outreach during the new legislation and the platform numbers for impressions on AmazingProductXYZ would be lower as a result. In some embodiments, the external factor may be associated with an event (e.g., new legislation) that affected at least one platform of the plurality of platforms. In a non-limiting example, affecting the at least one platform of the plurality of platforms may a temporal change in data associated at least in part with the event from the at least one platform of the plurality of platforms such as new legislation regulating sale of a particular product for a few months.

At 906, the GMS may provide input data and the external factor data to a generative model (e.g., generative model 408 with respect to FIG. 4). The input data and the external factor data may be combined into a dataset or may be supplied to the generative model together in one or more prompts. In some embodiments, the flow may include generating a temporal decomposition (e.g., delineated data by a time interval) of the input data for the generative model and inputting the temporal decomposition into the generative model along with the input data and the external factor data. The data may be incorporated as a single data set and/or may be provided a combination of data sets.

At 908, the GMS may receive output data of the generative model. The output data may include at least one platform function for each platform of the set of platforms. The platform functions may be distribution sets (e.g., using Bayesian regression or similar). In some examples, the platform functions may include platform simulations. The platform simulations may include multiple variables estimated for a given temporal decomposition (e.g., as discussed with respect to 906) associated with the input data. For example, if the input data spanning a time interval of January to December 2024 for a radio marketing spend including customer impressions values, then an associated platform simulation may include output data spanning a time interval of January to December 2025 including customer impression values. In some examples, a temporal function (e.g., a function associated with the time interval of the input data) may be generated and applied to other platforms (as discussed in more detail with respect to FIG. 4).

At 910, the GMS may determine one or more bounds on variables associated with the output data based at least in part on real-world observations data or historical output data. The bounds may be based at least in part on generated and/or variables based on real-world observations derived from platforms, internal testing, one or more historical platforms, platform associated reference thresholds, historical values, and/or industry benchmarks. For example, one bound includes using a Rhat diagnostic tool. The Rhat tool monitors between and within chain parameter estimates from the sampling. This metric must be within 0.95<1<1.05 to ensure adequate confidence in the sampling. If Rhat is outside of these bounds, sampling using the selected feature cannot be confidently performed.

At 912, the GMS may generate an optimization metric based at least in part on the bounds and a sampling of the variables. The sampling of variables may include generating a poster distribution. For example, regarding sampling, Hamiltonian or Markov Chain Monte Carlo sampling may be leveraged to sample from the posterior distributions of each platform to provide a distribution of simulated coefficients. Sampling the variables allows for the incorporation of external data/knowledge/logic when estimating new simulation coefficients with limited observed data. Representing each simulation coefficient as a distribution allowing for clear quantification of uncertainty. Generating the optimization metric may include obtaining current distribution variables (e.g., known or measured values for the variables) from the sampling and generating target distribution variables (e.g., simulated/future values for the variables) based at least in part on the input data and the bounds.

In some embodiments, generating the optimization metric may include determining a first set of simulation coefficients associated with the input data based at least in part on the current distribution variables and the target distribution variables such that the first set of simulated coefficients represent future estimates associated with the input data. In some examples, training the generative model may include retraining the generative model with the first set of simulation coefficients.

At 914, the GMS may train the generative model with the optimization metric to define a trained generative model. The generative model may be tuned repeatedly according to a predefined schedule (e.g., daily, weekly, quarterly, yearly) or by user preference. In some embodiments, additional input data (e.g., impressions) related to a second set of platforms (e.g., internet streaming services) may be provided to the trained generative model. The trained generative model may generate an estimated influence metric (e.g., simulated impressions for users over a future time interval) for one or more users associated with the second set of platforms and the GMS may generate, by a graphical user interface, a report including the estimated influence metric.

In some examples, the GMS may provide to the trained generative model, second input data (e.g., new unanalyzed data), where the second input data may be associated with a second set of platforms (e.g., an unknown set of platforms). The GMS may receive from the trained generative model, a second set of simulated coefficients based at least in part on the second input data and the external factor data (e.g., known events or predicted events). The second set of simulated coefficients may represent future estimates (e.g., or simulations) associated with the second input data. In some examples, the trained generative model may be retrained with the second set of simulated coefficients and the first set of simulated coefficients to define a retrained generative model, providing, to the retrained generative model, i) the input data, ii) the second input data, or iii) both. In addition, or alternatively the retrained generative model may provide a third set of simulated coefficients to the GMS, where the third set of simulated coefficients represent future estimates associated with i) the input data, ii) the second input data, or iii) both.

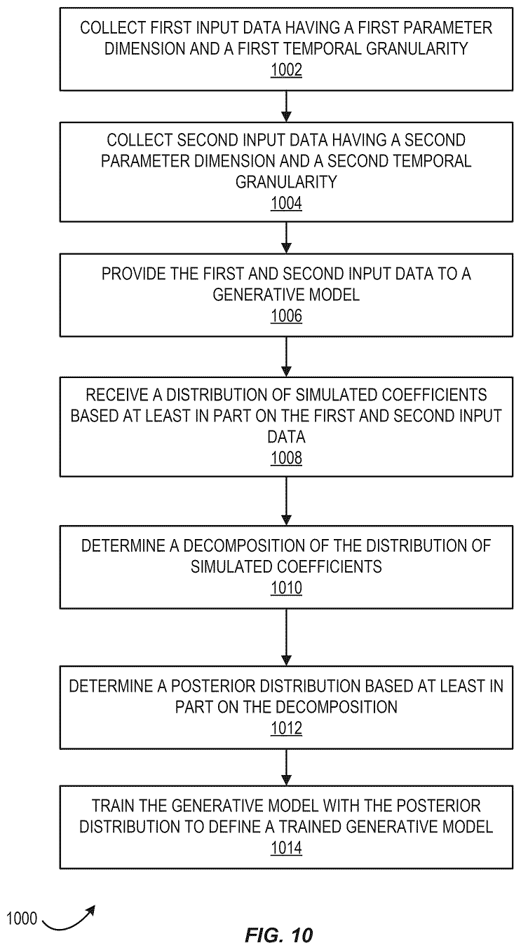

FIG. 10 is a block diagram illustrating an example method, in accordance with at least one embodiment. A non-transitory computer-readable storage medium may store computer-executable instructions that, when executed by at least one processor, cause at least one computer to perform instructions comprising the operations of the method 1000. It should be appreciated that the operations of the method 1000 may be performed in any suitable order, not necessarily the order depicted in FIG. 10. Further, the method 1000 may include additional, or fewer operations than those depicted in FIG. 10. The operations of method 1000 may be performed by any suitable portion of the device of FIG. 1 which may include one or more computing devices such as computing device 718 of FIGS. 7 and/or 8.

FIG. 10 is a block diagram illustrating an example method 1000 for tuning a generative model, in accordance with at least one embodiment. A non-transitory computer-readable storage medium may store computer-executable instructions that, when executed by at least one processor, cause at least one computer to perform instructions comprising the operations of the method 1000. It should be appreciated that the operations of the method 1000 may be performed in any suitable order, not necessarily the order depicted in FIG. 10. Further, the method 1000 may include additional, or fewer operations than those depicted in FIG. 10. The operations of method 1000 may be performed by any suitable portion of the device of FIG. 1 which may include one or more computing devices such as computing device 718 of FIGS. 7 and/or 8.

At 1002, a GMS (which is an example of GMS 102 with respect to FIG. 1) may collect first input data having a first parameter dimension and a first temporal granularity. The first input data (e.g., input data 230 with respect to FIG. 2) may be collected from one or more platforms (e.g., platforms 201 with respect to FIG. 2). In some examples, the platforms may be disparate (e.g., a TV marketing source, a Radio marketing source, etc.). The first parameter dimension may include any suitable number of dimensions (e.g., name, date, amount, impressions, location, view count, etc.) and the first temporal granularity may include any suitable number of time intervals associated with the first parameter dimension (e.g.,

[symbol]

At 1004, second input data may be collected from a second platform. The second input data may have a second parameter dimension and a second temporal granularity. In some examples, the first parameter dimension may be different than the second parameter dimension, and the first temporal granularity dimension may be different than the second temporal granularity dimension. For example, the first parameter dimension can include four dimensions: platform source, number of impressions, years where impressions were measured, and how many years occurred. The second parameter dimension can include three dimensions: platform source, weeks where impressions were measured, and how many weeks occurred.

At 1006, the GMS may provide the first and second input data to a generative model. The generative model may be a large language model which receives the first and second input data in the form a prompt.

At 1008, the GMS may receive a distribution of simulated coefficients (e.g., future weight estimates) based at least in part on the first and/or second input data. The simulated coefficients may be provided for one or more of the first and/or second parameter dimensions. In some embodiments, the simulated coefficients are weighted percentages (e.g., 0.7, 0.5, 0.4, etc.) associated with at least one dimension of the first and/or second input data.

At 1010, the GMS may determine a decomposition of the distribution of simulated coefficients. For example, the GMS may decompose the distribution into seasonal weights (e.g., future Winter percentages), simulated trends (e.g., trending upwards, downwards, patterns, etc.), and/or random components (e.g., sampled data which demonstrates an attribute of the distribution).

At 1012, the GMS may determine a posterior distribution based at least in part on the decomposition. By way of a non-limiting example, the posterior distribution may weight the output of the generative model with previous seasonal weights associated with the first or second dimension parameter. In some examples, the posterior distribution may incorporate historical values (e.g., previous calculated values from a look-up table or user provided) to mitigate overfitting observed data (e.g., ensuring the results make sense) and the distribution of simulated coefficients (e.g., simulated coefficients 674 with respect to FIG. 6) by the generative model (e.g., generative model 508 with respect to FIG. 5).

At 1014, the GMS may train the generative model with the posterior distribution to define a trained generative model. The posterior distributions may be based on real-world observations from one or more platforms (e.g., media platforms, internal testing, industry benchmarks, etc.). In some examples, the GMS may determine one or more external factors (e.g., World Cup happening on Day-Month-Year) based on a prior generative model output and applying the one or more external factors to the first or second input. For example, if the World Cup happens each year, the day month and year it typically happens on may be accounted for and correlated with data in the first or second input. In some embodiments, the GMS may retrain the generative model based at least in part on the external factors. In addition, or alternatively, the GMS may train additional generative models based at least in part on the decomposition and the external factors and provide a target and or decomposition-aware generative model (e.g., a model that specializes in seasonal trends versus a model which specializes in political trends).

In some embodiments, the GMS may provide a third input to the trained generative model, wherein the third input is associated with a third set of platforms having a set of third parameter dimensions and receive, from the trained generative model, a distribution of likely outcomes (e.g., if a particular event were to occur, a weight for a platform may be adjusted) for each dimension within the set of third parameter dimensions sample variables from the third parameter. The GMS may generate a set of confidence intervals for each platform of the third set of platforms such that each confidence interval of the set of confidence intervals is generated for each variable sampled from the third parameter and based at least in part on the posterior distribution.

By way of a non-limiting example, input data from internal and/or external sources may be received. The input data can represent new checking account households and may be received from data sources (e.g., Enterprise Data Warehouse/Snowflake and/or Google™ analytics). The platforms can include Google™, The Trade Desk, META™, Pinterest™, etc. The input data may include categorical variables (e.g., dimensions). In this example, the input data may include Customer Designated Media Area (DMA) of Residence, fields that may contain standardized text (“Columbus, OH”) or an integer value where the relationships are defined. For continuous variables, such as media impressions, the field can be non-negative or take on a value of zero indicating no impressions were shown during a time frame. In addition to summaries variables and household demographics, the input data may contain counts of businesses, competitors, retailers, household growth rate, and other spatial variables within a geographical region.

Examples of platforms and associated input data are, without limitation, in the form of “platform: variable”: i) Google Ads: Paid Search & Google Static Display, ii) Google Video: YouTube Video (OLV), iii) Bing Ads Microsoft Bing Paid Search, iv) Facebook Ads: META Static Display & Online Video, v) Trade Desk Ads: Trade Desk Static Display, Streaming Audio, Connected TV & OLV, vi) Shipyard Post Logs: TV & Radio actuals; vii) Broadcast Media Plans: Historical planned GRPs for TV, Radio & OLV, viii) Resolution Emerging Platforms: Snapchat, TikTok, Pinterest & Nextdoor display, xi) Merkle Historical Digital: Pre-Apr 2021 data for static display, x) Comperemedia Direct Mail: Competitive direct mail circulation by month/competitor, and/or combinations thereof.

The generative model may receive the input data along with external factor data. The external factors can include seasonality, geographic factors, distribution (bank branch counts) and macroeconomic features. For example, if the input data includes data relating to how many customers opened new checking accounts in regions where the new checking accounts were marketed on television, but during two weeks out of the year a popular sports activity is watched by ninety percent of the population in that region, then the input data would be affected by the external factor. In this manner, the input data may be supplied with the external factor data to the generative model. The generative model may provide an output including simulations (e.g., future predictions) which may be decomposed by a time interval (e.g., seasonal decomposition). In this example, the simulations may factor in the external factor of anticipating the popular sports activity.

In some examples, a generative model system (GMS) may retrieve and apply one or more bounds and/or posterior distributions to the variables associated with the output data. For example, it may be uncommon in the region for new checking accounts to be opened in Winter. If the generative model produces simulated coefficients (associated with the simulations) that predict an increase in new checking accounts for a future winter time interval, the bounds (or posterior distributions) may limit and/or otherwise mitigate these results as being outside of the norm (or unrealistic). Based on the bounds and/or posterior distributions, the GMS may generate an optimization metric. In some examples, the optimization metric may incorporate a random sampling of the output of the generative model. Returning to the non-limiting example, the optimization metric in this example may include a weighting percentage for a number of households in a region which are expected to open new checking accounts during the next year which is based on real-world observations of the previous year. As new data is acquired by the GMS, the generative model may be iteratively and/or continually trained. For example, input data from the platforms may be retrieved on a daily basis and provided to the generative model to train the model. The bounds and/or posterior distributions may be updated as time moves forward with more recent data.

The various embodiments further can be implemented in a wide variety of operating environments, which in some cases can include one or more user computers, computing devices or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system can include a number of workstations running any of a variety of commercially available operating systems and other known applications for purposes such as development and database management. These devices can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers, and business application servers. The server(s) may be capable of executing programs or scripts in response to requests from user devices, such as by executing one or more Web applications that may be implemented as one or more scripts or programs written in any programming language, such as Java®, C, C #, or C++, or any scripting language, such as Perl, Python, or TCL, as well as combinations thereof. The server(s) may include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may include one or more storage devices, such as disk drives, optical storage devices, and solid-state storage devices such as random-access memory (“RAM”) or read-only memory (“ROM”), as well as removable media devices, memory cards, flash cards, etc.

Such devices can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices typically will include a number of software applications, systems, services, or other elements located within at least one working memory device, including an operating system and application programs, such as a client application or Web browser. It should be appreciated that alternate embodiments may have numerous variations from that described above. For example, customized hardware might be used and/or particular elements might be implemented in hardware, software (including portable software, such as applets), or both. Further, connection to other computing devices such as network input/output devices may be employed.

Storage media computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program systems, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Where terms are used without explicit definition as recited herein, it is understood that the ordinary meaning of the word is intended, unless a term carries a special meaning in the field of anomaly detection or other relevant fields. The terms “about” or “substantially”, “similar to”, “similar”, “approximately” are used to indicate a deviation from the stated property or numerical value within which the deviation has little to no influence of the corresponding function, property, or attribute of the structure being described. In an illustrated example, where a dimensional parameter is described as “substantially equal” to another dimensional parameter, the term “substantially” is intended to reflect that the two dimensions being compared can be unequal within a tolerable limit, such as a fabrication tolerance. In the present disclosure, “ranges” refers to a range of values between the two stated extents and/or including one of the two stated extents.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A computer-implemented method comprising:
collecting, from a first platform, first input data having a first parameter dimension and a first temporal granularity;
collecting, from a second platform, second input data having a second parameter dimension and a second temporal granularity;
lowering a dimension of the first input data and the second input data by removing one or more dimensional variables to produce lower-dimensional input data;
providing the lower-dimensional input data to a generative model;
executing variable scaling on the lower-dimensional input data to produce adjusted lower-dimensional input data that i) reduces outlier variables, ii) weights outlier variables differently, or both i) and ii);
receiving, from the generative model, a first distribution of simulated coefficients based at least in part on the adjusted lower-dimensional input data;
determining a temporal decomposition of the first distribution of simulated coefficients corresponding to temporal intervals based at least in part on i) the first temporal granularity, ii) the second temporal granularity, or both i) and ii);
applying a statistical sampling on the temporal decomposition based at least in part on a normalization of the first distribution of simulated coefficients to produce an adjusted temporal decomposition;
generating a posterior distribution based at least in part on the adjusted temporal decomposition, wherein the posterior distribution incorporates each temporal interval of the temporal intervals to mitigate overfitting of the first distribution of simulated coefficients;
generating an optimization metric based at least in part on the posterior distribution;
generating, based at least in part on the optimization metric, a second distribution of simulated coefficients by removing or reducing simulated coefficients from the first distribution of simulated coefficients that are not correlated to a real-world event associated with at least one of the first platform or the second platform;
training the generative model with the second distribution of simulated coefficients to define a trained generative model; and
generating, by the trained generative model, output data including influence metrics associated with the i) the first platform, ii) the second platform, or both i) and ii) in accordance with the real-world event and the adjusted temporal decomposition.

2. The computer-implemented method of claim 1, wherein the first parameter dimension is different than the second parameter dimension and the first temporal granularity is different than the second temporal granularity.

3. The computer-implemented method of claim 1, wherein the first platform and the second platform are disparate platforms.

4. The computer-implemented method of claim 1, wherein the posterior distribution incorporates historical values to further mitigate overfitting observed data and the first distribution of simulated coefficients by the generative model.

5. The computer-implemented method of claim 1, further comprising:
determining one or more external factors associated with the real-world event based on a prior generative model output;
applying the one or more external factors to i) the first input data, ii) the second input data, the lower-dimensional input data, iv) the adjusted lower-dimensional input data, or v) any combination of i)-iv); and
retraining the trained generative model based at least in part on the external factors.

6. The computer-implemented method of claim 5, further comprising:
training one or more additional generative models based at least in part on the adjusted temporal decomposition and the external factors.

7. A computing device, comprising:
one or more processors; and
one or more memories storing computer-executable instructions that, when executed by the one or more processors, causes the one or more processors to:
collect, from a first platform, first input data having a first parameter dimension and a first temporal granularity;
collect, from a second platform, second input data having a second parameter dimension and a second temporal granularity;
lower a dimension of the first input data and the second input data by removing one or more dimensional variables to produce lower-dimensional input data;
provide the lower-dimensional input data to a generative model;
execute variable scaling on the lower-dimensional input data to produce adjusted lower-dimensional input data that i) reduces outlier variables, ii) weights outlier variables differently, or both i) and ii);
receive, from the generative model, a first distribution of simulated coefficients based at least in part on the adjusted lower-dimensional input data;
determine a temporal decomposition of the first distribution of simulated coefficients corresponding to temporal intervals based at least in part on i) the first temporal granularity, ii) the second temporal granularity, or both i) and ii);
apply a statistical sampling on the temporal decomposition based at least in part on a normalization of the first distribution of simulated coefficients to produce an adjusted temporal decomposition;
generate a posterior distribution based at least in part on the adjusted temporal decomposition, wherein the posterior distribution incorporates each temporal interval of the temporal intervals to mitigate overfitting of the first distribution of simulated coefficients;
generating an optimization metric based at least in part on the posterior distribution;
generate based at least in part on the optimization metric, a second distribution of simulated coefficients by removing or reducing simulated coefficients from the first distribution of simulated coefficients that are not correlated to a real-world event associated with at least one of the first platform or the second platform;
train the generative model with the second distribution of simulated coefficients to define a trained generative model; and
generate, by the trained generative model, output data including influence metrics associated with the i) the first platform, ii) the second platform, or both i) and ii) in accordance with the real-world event and the adjusted temporal decomposition.

8. The computing device of claim 7, wherein the first parameter dimension is different than the second parameter dimension and the first temporal granularity is different than the second temporal granularity.

9. The computing device of claim 7, wherein the first platform and the second platform are disparate platforms.

10. The computing device of claim 7, wherein the posterior distribution incorporates historical values to further mitigate overfitting observed data and the first distribution of simulated coefficients by the generative model.

11. The computing device of claim 7, wherein the instructions further cause the one or more processors to:
determine one or more external factors associated with the real-world event based on a prior generative model output;
apply the one or more external factors to i) the first input data, ii) the second input data, the lower-dimensional input data, iv) the adjusted lower-dimensional input data, or v) any combination of i)-iv); and
retrain the trained generative model based at least in part on the external factors.

12. The computing device of claim 11, wherein the instructions further cause the one or more processors to:
train one or more additional generative models based at least in part on the adjusted temporal decomposition and the external factors.

13. A non-transitory computer-readable storage medium storing computer-executable instructions that, when executed by one or more processors of a computing device, causes the one or more processors to:
collect, from a first platform, first input data having a first parameter dimension and a first temporal granularity;
collect, from a second platform, second input data having a second parameter dimension and a second temporal granularity;
lower a dimension of the first input data and the second input data by removing one or more dimensional variables to produce lower-dimensional input data;
provide the lower-dimensional input data to a generative model;
execute variable scaling on the lower-dimensional input data to produce adjusted lower-dimensional input data that i) reduces outlier variables, ii) weights outlier variables differently, or both i) and ii);
receive, from the generative model, a first distribution of simulated coefficients based at least in part on the adjusted lower-dimensional input data;
determine a temporal decomposition of the first distribution of simulated coefficients corresponding to temporal intervals based at least in part on i) the first temporal granularity, ii) the second temporal granularity, or both i) and ii);
apply a statistical sampling on the temporal decomposition based at least in part on a normalization of the first distribution of simulated coefficients to produce an adjusted temporal decomposition;
generate a posterior distribution based at least in part on the adjusted temporal decomposition, wherein the posterior distribution incorporates each temporal interval of the temporal intervals to mitigate overfitting of the first distribution of simulated coefficients;
generate an optimization metric based at least in part on the posterior distribution;
generate, based at least in part on the optimization metric, a second distribution of simulated coefficients by removing or reducing simulated coefficients from the first distribution of simulated coefficients that are not correlated to a real-world event associated with at least one of the first platform or the second platform;
train the generative model with the second distribution of simulated coefficients to define a trained generative model; and
generate, by the trained generative model, output data including influence metrics associated with the i) the first platform, ii) the second platform, or both i) and ii) in accordance with the adjusted temporal decomposition.

14. The non-transitory computer-readable storage medium of claim 13, wherein the first parameter dimension is different than the second parameter dimension and the first temporal granularity is different than the second temporal granularity.

15. The non-transitory computer-readable storage medium of claim 13, wherein the first platform and the second platform are disparate platforms.

16. The non-transitory computer-readable storage medium of claim 13, wherein the posterior distribution incorporates historical values to mitigate overfitting observed data and the first distribution of simulated coefficients by the generative model.

17. The non-transitory computer-readable storage medium of claim 13, wherein the instructions further cause the one or more processors to:
determine one or more external factors associated with the real-world event based on a prior generative model output;
apply the one or more external factors to i) the first input data, ii) the second input data, the lower-dimensional input data, iv) the adjusted lower-dimensional input data, or v) any combination of i)-iv); and
retrain the trained generative model based at least in part on the external factors.

18. The non-transitory computer-readable storage medium of claim 17, wherein the instructions further cause the one or more processors to:
train one or more additional generative models based at least in part on the adjusted temporal decomposition and the external factors.

19. The non-transitory computer-readable storage medium of claim 13, wherein the instructions further cause the one or more processors to:
provide a third input data to the trained generative model, wherein the third input data is associated with a third set of platforms having a set of third parameter dimensions; and
receive, from the trained generative model, a distribution of likely outcomes for each dimension within the set of third parameter dimensions based at least in part on the third input data.

20. The non-transitory computer-readable storage medium of claim 19, wherein the instructions further cause the one or more processors to:
sample variables from the third input data; and
generate a set of confidence intervals for each platform of the third set of platforms, wherein each confidence interval of the set of confidence intervals is generated for each variable sampled from the third input data and based at least in part on the posterior distribution.
